(19) United States
(12) Patent Application Publication
(10) Pub. No.: US 2014/0139509 A1
(43) Pub. Date: May 22, 2014

(54) PAD AREAS, DISPLAY PANELS HAVING THE SAME, AND FLAT PANEL DISPLAY DEVICES

(71) Applicant: Samsung Display Co., Ltd., Yongin-City (KR)

(72) Inventor: Dong-Wook KIM, Yongin-City (KR)

(21) Appl. No.: 13/959,940

(22) Filed: Aug. 6, 2013

(30) Foreign Application Priority Data
Nov. 19, 2012 (KR) 10-2012-0130911

(51) Int. Cl. G09G 5/00; G09G 3/36; G09G 3/32

(52) U.S. Cl. CPC G09G 5/00; G09G 3/3275; G09G 3/3688
USPC 345/212; 345/82; 345/90

(57) ABSTRACT

A pad area of a display panel having a plurality of pixel circuits is provided. The pad area includes at least one driving pad coupled to a data-line or a scan-line, at least one test pad coupled to a first line for transmitting a test signal to the pixel circuits and a second line for transmitting a driving control signal to the pixel circuits, at least one first transistor that controls an electrical coupling between the first line and the test pad, and at least one second transistor that controls an electrical coupling between the second line and the test pad.

### CLAIM PRIORITY

This application makes reference to, incorporates the same herein, and claims all benefits accruing under 35 U.S.C. §119 from an application earlier filed in the Korean Intellectual Property Office on 19 Nov. 2012 and there duly assigned Serial No 10-2012-0130911.

### BACKGROUND OF THE INVENTION

1. Field of the Invention

Example embodiments relate generally to flat panel display devices.

2. Description of the Related Art

Recently, a liquid crystal display (LCD) device and an organic light emitting display (OLED) device are widely used as a flat panel display device. Generally, a lighting test for detecting a pixel defect and an aging test for inspecting reliability are performed on the flat panel display device before a module process that bonds a driving integrated circuit and a flexible printed circuit (FPC) to a display panel.

The above information disclosed in this Related Art section is only for enhancement of understanding of the background of the invention and therefore it may contain information that does not form the prior art that is already known to a person of ordinary skill in the art.

### SUMMARY OF THE INVENTION

Example embodiments provide a pad area having a relatively small (i.e., reduced) area, the pad area having at least one test pad capable of operating as a driving pad after a lighting test.

Example embodiments provide a display panel having the pad area.

Example embodiments provide a flat panel display device having the display panel.

According to some example embodiments, a pad area of a display panel having a plurality of pixel circuits may include at least one driving pad coupled to a data-line or a scan-line, at least one test pad coupled to a first line for transmitting a test signal to the pixel circuits and a second line for transmitting a driving control signal to the pixel circuits, at least one first transistor configured to control an electrical coupling between the first line and the test pad, and at least one second transistor configured to control an electrical coupling between the second line and the test pad.

In example embodiments, the pad area may include a first control pad configured to receive a first control voltage for turning-on or turning-off the first transistor, and a second control pad configured to receive a second control voltage for turning-on or turning-off the second transistor.

In example embodiments, the test pad may include a first pad coupled to the first line, and a second pad coupled to the second line.

In example embodiments, the first transistor may be coupled between the first line and the first pad.

In example embodiments, the second transistor may be coupled between the second line and the second pad.

In example embodiments, the first transistor may turn-on based on the first control voltage during a test period, and the first line may be electrically coupled to the first pad when the first transistor turns-on.

In example embodiments, the second transistor may turn-off based on the second control voltage during the test period, and the second line may be electrically blocked from the first pad when the second transistor turns-off.

In example embodiments, the second transistor may turn-on based on the second control voltage during a driving period, and the second line may be electrically coupled to the first pad when the second transistor turns-on.

In example embodiments, the first transistor may turn-off based on the first control voltage during the driving period, and the first line may be electrically blocked from the first pad when the first transistor turns-off.

In example embodiments, the test pad may transmit the driving control signal to the pixel circuits through the second line during the driving period.

In example embodiments, the driving control signal may correspond to a touch panel signal.

According to some example embodiments, a display panel may include a plurality of pixel circuits, a driving integrated circuit configured to provide a driving signal to the pixel circuits and a pad area having at least one test pad that may be coupled to a first line for transmitting a test signal to the pixel circuits and a second line for transmitting the driving control signal to the pixel circuits, wherein the test pad may be electrically controlled by at least one first transistor coupled to the first line and at least one second transistor coupled to the second line.

In example embodiments, the pad area may include a first control pad configured to receive a first control voltage for turning-on or turning-off the first transistor, and a second control pad configured to receive a second control voltage for turning-on or turning-off the second transistor.

In example embodiments, the first transistor may turn-on based on the first control voltage during the test period, and the first line may be electrically coupled to the first pad when the first transistor turns-on.

In example embodiments, the second transistor may turn-off based on the second control voltage during the test period, and the second line may be electrically blocked from the first pad when the second transistor turns-off.

In example embodiments, the second transistor may turn-on based on the second control voltage during the driving period, and the second line may be electrically coupled to the second pad when the second transistor turns-on.

In example embodiments, the first transistor may turn-off based on the first control voltage during the driving period, and the first line may be electrically blocked from the first pad when the first transistor turns-off.

In example embodiments, the test pad may transmit the driving control signal to the pixel circuits through the second line during the driving period.

According to some example embodiments, a flat panel display device may include a display panel having a plurality of pixel circuits, a scan driving unit configured to provide a scan signal to the pixel circuits, a data driving unit configured to provide a data signal to the pixel circuits, a timing control unit configured to control the scan driving unit and the data driving unit and a pad area having at least one test pad that may be coupled to a first line for transmitting a test signal to the pixel circuits and a second line for transmitting a driving control signal to the pixel circuits, wherein the test pad may be controlled by at least one first transistor coupled to the first line and at least one second transistor coupled to the second line.

In example embodiments, the flat panel display device may correspond to an organic light emitting display device that includes the pixel circuits each having an organic light emitting diode or a liquid crystal display device that includes the pixel circuits each having a liquid crystal layer.

Therefore, a pad area in accordance with example embodiments may have a relatively small (i.e., reduced) area based on at least one test pad that performs a function (i.e., operation) of a driving pad after a lighting test.

In addition, a display device having the area pad in accordance with example embodiments may need no test pad cutting process after a lighting test. As a result, the display panel may prevent damages due to an inflow of a static electricity occurring during the conventional test pad cutting process.

Furthermore, a flat panel display device having the display panel in accordance with example embodiments may simplify a module process, and may decrease a cost for manufacturing the flat panel display device.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a diagram illustrating a pad area according to example embodiments.

FIG. 2 is a diagram illustrating an example in which a pad area of FIG. 1 provides a test signal to pixel circuits.

FIG. 3 is a diagram illustrating an example in which a pad area of FIG. 1 provides a driving control signal to pixel circuits.

FIG. 4 is a diagram illustrating a display panel according to example embodiments.

FIG. 5 is a diagram illustrating an example in which a test signal is provided to a display panel of FIG. 4.

FIG. 6 is a diagram illustrating an example in which a driving control signal is provided to a display panel of FIG. 4.

FIG. 7 is a block diagram illustrating a flat panel display device according to example embodiments.

FIG. 8 is a block diagram illustrating an electronic device having a flat panel display device of FIG. 7.

### DETAILED DESCRIPTION OF THE EMBODIMENTS

Various embodiments will be described more fully hereinafter with reference to the accompanying drawings, in which some embodiments are shown. The invention may, however, be embodied in many different forms and should not be construed as limited to the embodiments set forth herein. Rather, these embodiments are provided so that this description will be thorough and complete, and will fully convey the scope of the invention to those skilled in the art. In the drawings, the sizes and relative sizes of layers and regions may be exaggerated for clarity.

It will be understood that when an element or layer is referred to as being “on,” “coupled to” or “coupled to” another element or layer, it can be directly on, coupled or coupled to the other element or layer or intervening elements or layers may be present. In contrast, when an element is referred to as being “directly on,” “directly coupled to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (for example, rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include a plurality of forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments are described herein with reference to cross-sectional illustrations that are schematic illustrations of idealized embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the face through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

When a lighting test is performed to detect a pixel defect, a test pad area having test pads and test transistors is formed in a non-display region of the flat panel display device. However, an edge region of the display panel gets wider because the test pad area may be formed in the non-display region of the flat panel display device. Here, as a resolution of the display panel gets higher, the edge region of the display panel gets wider. In addition, as a size of the display panel gets bigger, the edge region of the display panel gets wider.

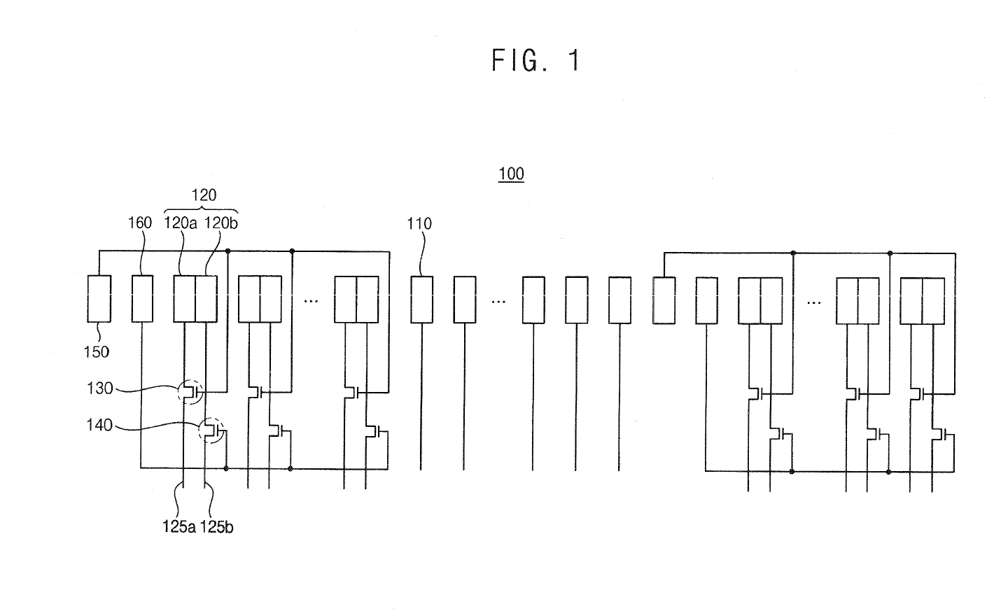

FIG. 1 is a diagram illustrating a pad area according to example embodiments.

Referring to FIG. 1, the pad area 100 may include at least one driving pad 110, at least one test pad 120, at least one first transistor 130, and at least one second transistor 140.

The driving pad 110 may be coupled to a data-line or a scan-line. In detail, the driving pad 110 may include a data driving pad coupled to the data-line for supplying a data signal to pixel circuits and/or a scan driving pad coupled to the scan-line for supplying a scan signal to the pixel circuits.

The test pad 120 may include a first pad 120a for supplying a test signal to the pixel circuits, and a second pad 120b for supplying a driving control signal to the pixel circuits. Here, the first pad 120a and the second pad 120b may be defined (i.e., determined) according to those locations in the test pad 120. However, the first pad 120a may be formed using substantially the same material as the second pad 120b.

Specifically, the first pad 120a may be coupled to a first line 125a for transmitting the test signal to the pixel circuits, and the second pad 120b may be coupled to a second line 125b for transmitting the driving control signal to the pixel circuits. In other words, the test pad 120 may transmit the test signal through the first pad 120a and the first line 125a during a test process of a display panel. The test pad 120 may transmit the driving control signal through the second pad 120b and the second line 125b after the test process was completed (i.e., during a driving period of the display panel). The driving pad 110 may be used during the driving of the display panel. In one example embodiment, the driving control signal may be a touch panel signal. However, the driving control signal is not limited thereto.

The first transistor 130 may control an electric coupling between the first line 125a and the test pad 120. In detail, the first transistor 130 may be coupled to the first line 125a and the first pad 120a to control the electric coupling between the first line 125a and the test pad 120.

The second transistor 140 may control an electric coupling between the second line 125b and the test pad 120. In detail, the second transistor 140 may be coupled to the second line 125b and the second pad 120b to control the electric coupling between the second line 125b and the second pad 120b.

In example embodiments, the first transistor 130 may control the electric coupling between the first line 125a and the first pad 120a by turning-on or turning-off based on a first control voltage, where the first control voltage may be provided from a first control pad 150. As described above, the test signal may be transmitted to the pixel circuits through the first line 125a. In addition, the second transistor 140 may control the electric coupling between the second line 125b and the second pad 120b by turning-on or turning-off based on a second control voltage, where the second control voltage may be provided from a second control pad 160. As described above, the driving control signal may be transmitted to the pixel circuits through the second line 125b. It is illustrated in FIG. 1 that the first control pad 150 and the second control pad 160 are disposed on one side of the test pad 120. However, the present inventive concept is not limited thereto. For example, the first control pad 150 and the second control pad 160 may be disposed on a plurality of sides (e.g., left side, right side, upper side, lower side) of the test pad 120.

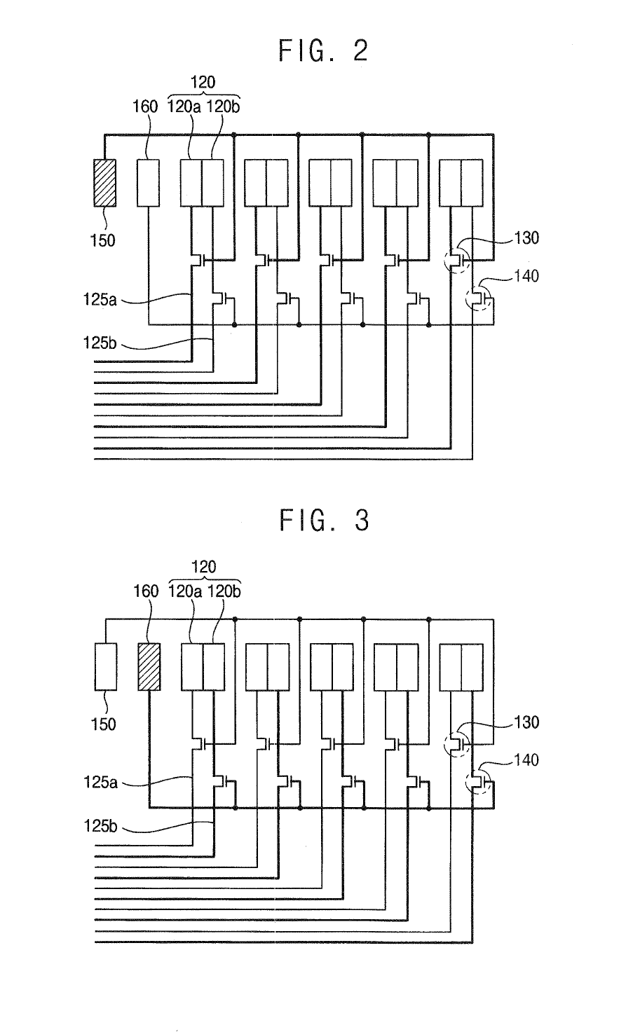

As described above, the pad area 100 may include the test pad 120 that performs a function (i.e., operation) of the driving pad 110 after the lighting test. As a result, the pad area 100 may have a relatively small (i.e., reduced) area. Hereinafter, referring to FIGS. 2 and 3, the pad area 100 will be described in detail.

FIG. 2 is a diagram illustrating an example in which a pad area of FIG. 1 provides a test signal to pixel circuits.

Referring to FIG. 2, the first transistor 130 may turn-on based on the first control voltage during the test period. The first control voltage may be provided from the first control pad 150. In this case, the first pad 120a may be electrically coupled to the first line 125a when the first transistor 130 turns-on. The second transistor 140 may turn-off based on the second control voltage during the test period. The second control voltage may be provided from the second control pad 160. In this case, the second pad 120b may be electrically blocked from the second line 125b when the second transistor 140 turns-off. Thus, the test pad 120 may transmit the test signal to the pixel circuits through the first pad 120a and the first line 125a during the test period.

FIG. 3 is a diagram illustrating an example in which a pad area of FIG. 1 provides a driving control signal to pixel circuits.

Referring to FIG. 3, the second transistor 140 may turn-on based on the second control voltage during the driving period. The second control voltage may be provided from the second control pad 160. In this case, the second pad 120b may be electrically coupled to the second line 125b when the second transistor 140 turns-on. The first transistor 130 may turn-off based on the first control voltage during the driving period. The first control voltage may be provided from the first control pad 150. In this case, the first pad 120a may be electrically blocked from the first line 125a when the first transistor 130 turns-off. Thus, the test pad 120 may transmit the driving control signal to the pixel circuits through the second pad 120b and the second line 125b during the driving period. In other words, the test pad 120 may also perform a function (i.e., operation) of the driving pad 110 based on a structure of the pad area 100 illustrated in FIG. 1. As a result, the pad area 100 may have a relatively small (i.e., reduced) area.

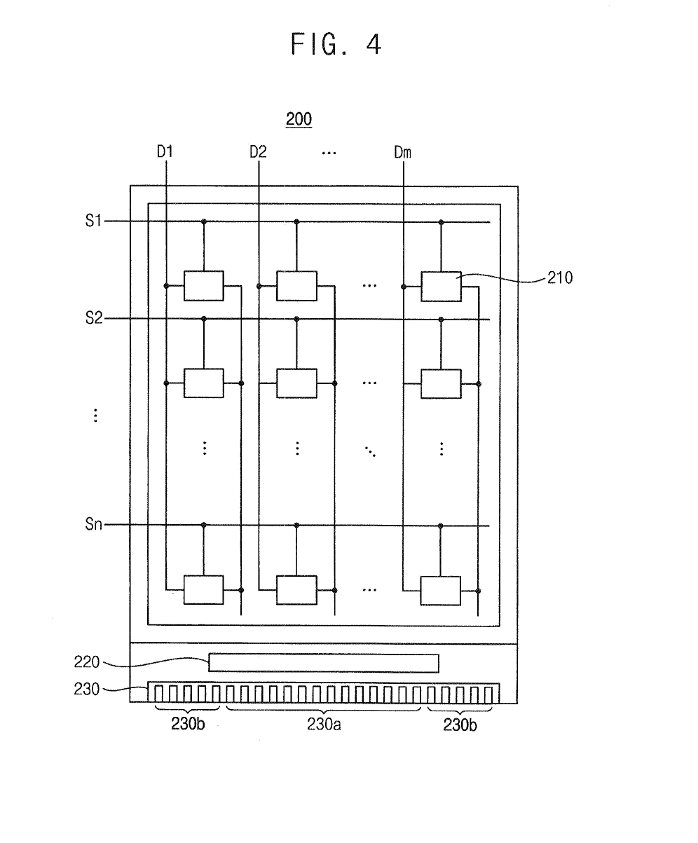

FIG. 4 is a diagram illustrating a display panel according to example embodiments.

Referring to FIG. 4, the display panel 200 may include a plurality of pixel circuits 210, a driving integrated circuit 220, and a pad area 230.

The pixel circuits 210 may be arranged at locations corresponding crossing points of scan-lines S1 through Sn and data-lines D1 through Dm. In one example embodiments, the pixel circuits 210 may have respective organic light emitting diodes. In another example embodiment, the pixel circuits 210 may have respective liquid crystal layers. However, the present inventive concept is not limited thereto.

In detail, the pixel circuits 210 may receive a scan signal via the scan-lines 51 through Sn. In addition, the pixel circuits 210 may receive a data signal via the data-lines D1 through Dm.

The driving integrated circuit 220 may receive the driving control signal through at least one driving pad 230a of the pad area 230 to generate a driving signal (e.g., the scan signal and the data signal). Specifically, the driving integrated circuit 220 may include a scan driving circuit for generating the scan signal and/or a data driving circuit for generating the data signal.

The pad area 230 may include a plurality of pads 230a and a plurality of test pads 230b. In detail, the pad area 230 may include at least one driving pad 230a for providing the driving control signal to the pixel circuits 210 and the driving integrated circuit 220, and at least one test pad 230b for providing the test signal and the driving control signal to the pixel circuits 210 and the driving integrated circuit 220.

In example embodiments, the test pad 230b may be coupled to the first line for transmitting the test signal to the pixel circuits 210, and to the second line for transmitting the driving control signal to the pixel circuits 210. Here, the pad area 230 may include at least one first transistor for controlling an electrical coupling between the first line and the test pad 230b, and at least one second transistor for controlling an electrical coupling between the second line and the test pad 230b. In one example embodiment, the driving control signal may be a touch panel signal. However, the driving control signal is limited thereto.

Since a conventional test pad only performs a function (i.e., operation) of the test pad, an electrical coupling between the test pad and one line should be cut after a defect pixel test of the display panel is completed. Here, the conventional test pad cutting process may result in damages due to an inflow of a static electricity.

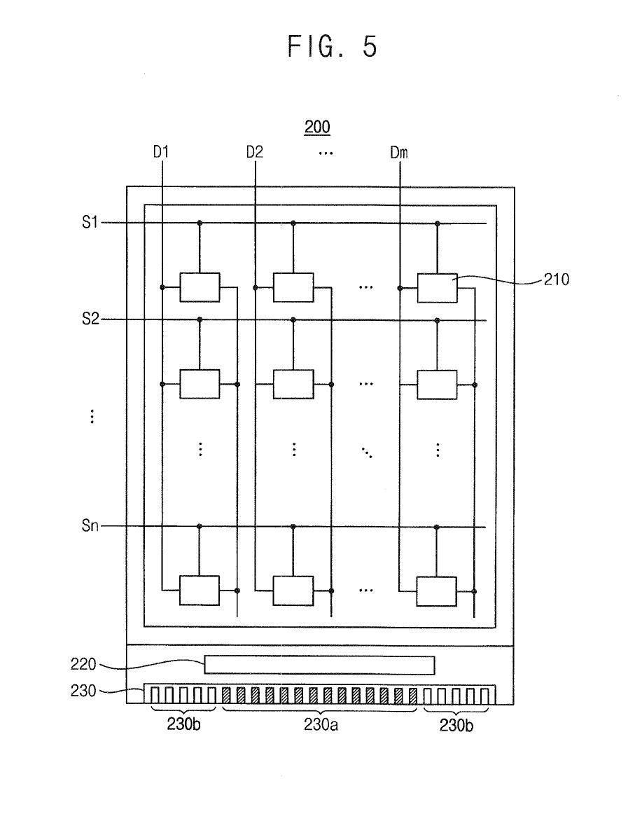

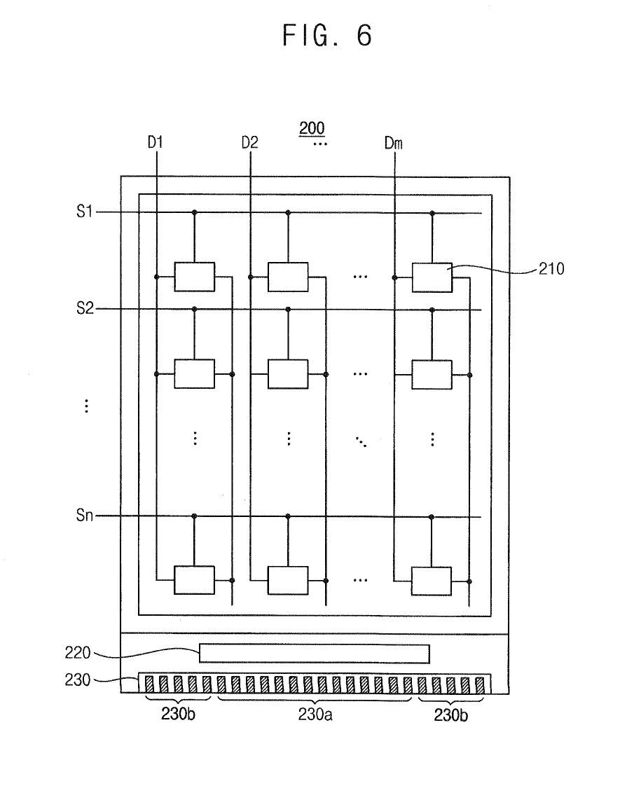

In example embodiments, the display panel may have the pad area 230 having a structure illustrated in FIG. 1. Hence, the display panel 200 may prevent an inflow of the static electricity occurring during the conventional test pad cutting process. In addition, the display panel 200 may minimize the area of the pad area 230 by including the test pad 230b that performs the function (i.e., operation) of the driving pad 230a after the lighting test. As a result, a display region of the display panel 200 may be efficiently used. Hereinafter, referring to FIGS. 5 and 6, the display panel 200 will be described in detail.

FIG. 5 is a diagram illustrating an example in which a test signal may be provided to a display panel of FIG. 4. FIG. 6 is a diagram illustrating an example in which a driving control signal may be provided to a display panel of FIG. 4.

As illustrated in FIG. 5, the pad area 230 may provide the test signal to the pixel circuits 210 through the first line coupled to the test pad 230b during the test period of the display panel 200. Here, the pad area 230 may control the electrical coupling between the test pad 230b and the first line based on operations of the first transistor coupled between the test pad 230b and the first line. In example embodiments, the pad area 230 may include the first control pad to turn-on or turn-off the first transistor. The first transistor may turn-on or turn-off in response to the first control voltage applied from the first control pad. In detail, the test pad 230b may be electrically coupled to the first line when the first control voltage may be transmitted to the first control pad (i.e., when the first transistor turns-on). Thus, the pad area 230 may provide the test signal to the pixel circuits 210 through the first line. In other words, the pixel circuits 210 may receive the test signal through the test pad 230b during the test period of the display panel 200.

As illustrated in FIG. 6, the pad area 230 may provide the driving control signal to the pixel circuits 210 through the second line coupled to the test pad 230b during the driving period of the display panel 200 after the test process is completed. Here, the pad area 230 may control the electrical coupling between the test pad 230b and the first line based on operations of the second transistor coupled between the test pad 230b and the second line. In example embodiments, the pad area 230 may include the second control pad to turn-on or turn-off the second transistor. The second transistor may turn-on or turn-off in response to the second control voltage applied from the second control pad. In detail, the test pad 230b may be electrically coupled to the second line when the second control voltage may be transmitted to the second control pad (i.e., when the second transistor turns-on). Thus, the pad area 230 may provide the driving control signal to the pixel circuits 210 through the second line. Meanwhile, the first transistor may turn-off in response to the first control voltage during the driving period of the display panel 200. In other words, the pixel circuits 210 may simultaneously receive the driving control signal through the test pad 230a and the driving pad 230b during the driving period of the display panel 200.

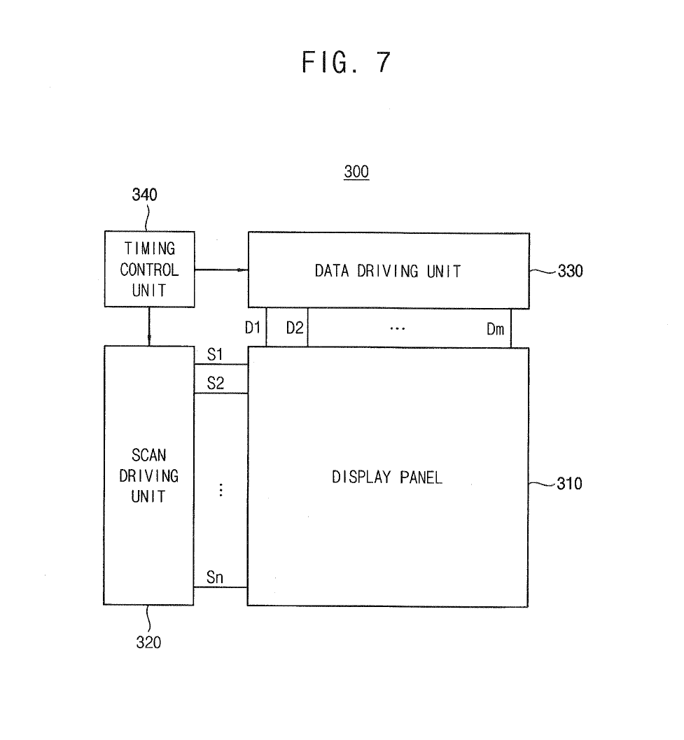

FIG. 7 is a block diagram illustrating a flat panel display device according to example embodiments.

Referring to FIG. 7, the flat panel display device 300 may include a display panel 310, a scan driving unit 320, a data driving unit 330, a timing control unit 340, and a pad area (not illustrated).

The display panel 310 may include a plurality of pixel circuits. Specifically, in the display panel 310, the pixel circuits may be arranged at location corresponding to crossing points of scan-lines S1 through Sn and data-lines D1 through Dm. Here, the display panel 310 may display an image based on the scan signal provided from the scan driving unit 320 and the data signal provided from the data driving unit 330.

The scan driving unit 320 may provide the scan signal to the pixel circuits. Specifically, the scan driving unit 320 may generate the scan signal in response to the scan driving control signal SCS provided from the timing control unit 340. The scan driving unit 320 may sequentially provide the scan signal to the scan-lines S1 through Sn.

The data driving unit 330 may provide the data signal to the pixel circuits. Specifically, the data driving unit 330 may generate the data signal in response to the data driving control signal provided from the timing control unit 340. The data driving unit 330 may provide the data signal to the data-lines D1 through Dm in synchronization with operations of the scan driving unit 320.

The timing control unit 340 may control the scan driving unit 320 and the data driving unit 330. Specifically, the timing control unit 340 may generate control signals, and may provide the control signals to the scan driving unit 320 and the data driving unit 330 to control the scan driving unit 320 and the data driving unit 330.

The pad area may be arranged in a lower region of the scan driving unit 320 or in a lower region of the data driving unit 330. Specifically, the pad area may include at least one driving pad for supplying the driving control signal to the pixel circuits and the driving integrated circuit, and at least one test pad for supplying the test signal and the driving control signal to the pixel circuits and the driving integrated circuit. Meanwhile, although it is illustrated in FIG. 5 that the pad area may be disposed on one side of a non-display region of the display panel 310, the present invention concept is not limited thereto. For example, the pad area may be selectively disposed on at least one side of a non-display region of the display panel 310.

In example embodiments, the test pad may be coupled to the first line for transmitting the test signal to the pixel circuits, and to the second line for transmitting the driving control signal to the pixel circuits. The pad area may include at least one first transistor for controlling an electrical coupling between the first line and the test pad, and at least one second transistor for controlling an electrical coupling between the second line and the test pad. Here, the pad area may be electrically coupled to a flexible printed circuit (FPC) having a film shape. In this case, the pad area may receive a power voltage, a driving control signal, and a test signal, etc via the FPC. In one example embodiment, the driving control signal may be a touch panel signal. However, the driving control signal is not limited thereto.

As described above, the test pad of the pad area of the flat panel display device 300 may operate as the driving pad after a lighting test. Thus, when the flat panel display device 300 is manufactured, conventional test pad cutting process after the lighting test may be omitted. As a result, a module process may be simplified and a cost for manufacturing the flat panel display device 300 may be reduced.

In one example embodiment, the flat panel display device 300 may be an organic light emitting display (OLED) device. In this case, the pixel circuits of the display panel 310 may have respective organic light emitting diodes. In another example embodiment, the flat panel display device 300 may be a liquid crystal display (LCD) device. In this case, the pixel circuits of the display panel 310 may have respective liquid crystal layers. However, a type of the flat panel display device 300 is not limited thereto.

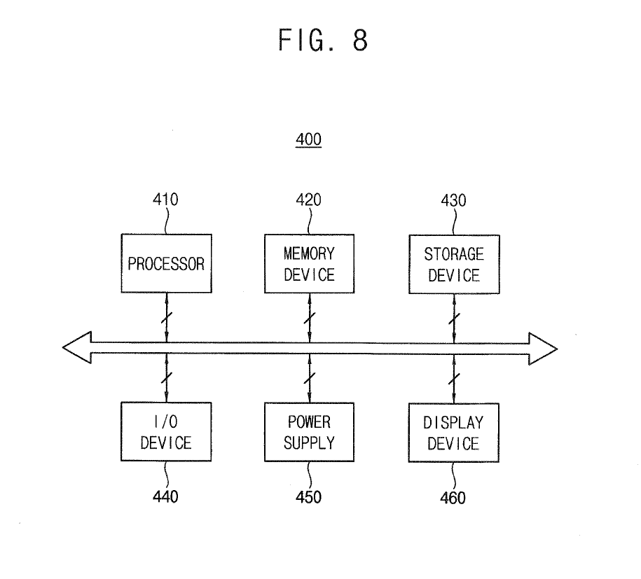

FIG. 8 is a block diagram illustrating an electronic device having a flat panel display device of FIG. 7.

Referring to FIG. 8, the electronic device 400 may include a processor 410, a memory device 420, a storage device 430, an input/output (I/O) device 440, a power provide 450, and a flat panel display device 460. Here, the flat panel display device 460 may correspond to the flat panel display device 200 of FIG. 5. In addition, the electronic device 400 may further include a plurality of ports for communicating a video card, a sound card, a memory card, a universal serial bus (USB) device, other electronic devices, etc.

The processor 410 may perform various computing functions. The processor 410 may be a micro processor, a central processing unit (CPU), etc. The processor 410 may be coupled to other components via an address bus, a control bus, a data bus, etc. Further, the processor 410 may be coupled to an extended bus such as a peripheral component interconnection (PCI) bus. The memory device 420 may store data for operations of the electronic device 400. For example, the memory device 420 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, etc, and/or at least one volatile memory device such as a dynamic random access memory (DRAM) device, a static random access memory (SRAM) device, a mobile DRAM device, etc. The storage device 430 may be a solid state drive (SSD) device, a hard disk drive (HDD) device, a CD-ROM device, etc.

The I/O device 440 may be an input device such as a keyboard, a keypad, a touchpad, a touch-screen, a mouse, etc, and an output device such as a printer, a speaker, etc. In some example embodiments, the flat panel display device 460 may be included in the I/O device 440. The power supply 450 may provide a power for operations of the electronic device 400. The flat panel display device 460 may communicate with other components via the buses or other communication links. As described above, the flat panel display device 460 may include the display panel, the scan driving unit, the data driving unit, the timing control unit, and the pad area. Here, the test pad of the pad area of the flat panel display device 460 may operate as the driving pad after a lighting test. To this end, the pad area of the flat panel display device 460 may include at least one driving pad, at least one test pad, at least one first transistor, and at least one second transistor. Since the pad area of the flat panel display device 460 is described above, duplicated descriptions will be omitted. In conclusion, the flat panel display device 460 may prevent damages due to an inflow of a static electricity occurring during the conventional test pad cutting process. As a result, the module process may be simplified, and the cost for manufacturing the flat display device may be reduced. The flat panel display device 460 may be an organic emitting display (OLED) device or a liquid crystal display (LCD) device. However, a type of the flat panel display device 460 is not limited thereto.

The present inventive concept may be applied to a system having a flay panel display device. For example, the present inventive concept may be applied to a computer monitor, a laptop, a digital camera, a cellular phone, a smart phone, a smart pad, a television, a personal digital assistant (PDA), a portable multimedia player (PMP), a MP3 player, a navigation system, a game console, a video phone, etc.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present inventive concept. Accordingly, all such modifications are intended to be included within the scope of the present inventive concept as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A pad area of a display panel having a plurality of pixel circuits, the pad area comprising:
at least one driving pad coupled to a data-line or a scan-line;
at least one test pad coupled to a first line for transmitting a test signal to the pixel circuits and a second line for transmitting a driving control signal to the pixel circuits;
at least one first transistor configured to control an electrical coupling between the first line and the test pad; and
at least one second transistor configured to control an electrical coupling between the second line and the test pad.

2. The pad area of claim 1, further comprising:
a first control pad configured to receive a first control voltage for turning-on or turning-off the first transistor; and
a second control pad configured to receive a second control voltage for turning-on or turning-off the second transistor.

3. The pad area of claim 2, wherein the test pad comprises:
a first pad coupled to the first line; and
a second pad coupled to the second line.

4. The pad area of claim 3, wherein the first transistor is coupled between the first line and the first pad.

5. The pad area of claim 4, wherein the second transistor is coupled between the second line and the second pad.

6. The pad area of claim 5, wherein the first transistor turns-on based on the first control voltage during a test period, and the first line is electrically coupled to the first pad when the first transistor turns-on.

7. The pad area of claim 6, wherein the second transistor turns-off based on the second control voltage during the test period, and the second line is electrically blocked from the second pad when the second transistor turns-off.

8. The pad area of claim 5, wherein the second transistor turns-on based on the second control voltage during a driving period, and the second line is electrically coupled to the second pad when the second transistor turns-on.

9. The pad area of claim 8, wherein the first transistor turns-off based on the first control voltage during the driving period, and the first line is electrically blocked from the first pad when the first transistor turns-off.

10. The pad area of claim 9, wherein the test pad transmits the driving control signal to the pixel circuits through the second line during the driving period.

11. The pad area of claim 10, the driving control signal corresponds to a touch panel signal.

12. A display panel, comprising:
a plurality of pixel circuits;
a driving integrated circuit configured to provide a driving signal to the pixel circuits; and
a pad area having at least one test pad that is coupled to a first line for transmitting a test signal to the pixel circuits and a second line for transmitting the driving control signal to the pixel circuits, the test pad is controlled by at least one first transistor coupled to the first line and at least one second transistor coupled to the second line.

13. The panel of claim 12, wherein the pad area comprises:
a first control pad configured to receive a first control voltage for turning-on or turning-off the first transistor; and
a second control pad configured to receive a second control voltage for turning-on or turning-off the second transistor.

14. The panel of claim 13, wherein the first transistor turns-on based on the first control voltage during a test period, and the first line is electrically coupled to the first pad when the first transistor turns-on.

15. The panel of claim 14, wherein the second transistor turns-off based on the second control voltage during the test period, and the second line is electrically blocked from the second pad when the second transistor turns-off.

16. The panel of claim 13, wherein the second transistor turns-on based on the second control voltage during a driving period, and the second line is electrically coupled to the second pad when the second transistor turns-on.

17. The panel of claim 16, wherein the first transistor turns-off based on the first control voltage during the driving period, and the first line is electrically blocked from the first pad when the first transistor turns-off.

18. The panel of claim 17, wherein the test pad transmits the driving control signal to the pixel circuits through the second line during the driving period.

19. A flat panel display device, comprising:
a display panel having a plurality of pixel circuits;
a scan driving unit configured to provide a scan signal to the pixel circuits;
a data driving unit configured to provide a data signal to the pixel circuits;
a timing control unit configured to control the scan driving unit and the data driving unit; and
a pad area having at least one test pad that is coupled to a first line for transmitting a test signal to the pixel circuits and a second line for transmitting a driving control signal to the pixel circuits, the test pad is controlled by at least one first transistor coupled to the first line and at least one second transistor coupled to the second line.

20. The device of claim 19, wherein the flat panel display device corresponds to an organic light emitting display device that includes the pixel circuits each having an organic light emitting diode or a liquid crystal display device that includes the pixel circuits each having a liquid crystal layer.
